(19) United States
(12) Patent Application Publication
(10) Pub. No.: US 2022/0045367 A1
(43) Pub. Date: Feb. 10, 2022

(54) BATTERY

(71) Applicant: MURATA MANUFACTURING CO., LTD., Kyoto (JP)

(72) Inventors: Daiki NISHIIE, Kyoto (JP); Hideaki TOKUGAWA, Kyoto (JP); Yoshiichi HORIKOSHI, Kyoto (JP)

(21) Appl. No.: 17/497,476

(22) Filed: Oct. 8, 2021

Related U.S. Application Data
(63) Continuation of application No. PCT/JP2020/015213, filed on Apr. 2, 2020.

(30) Foreign Application Priority Data
Apr. 9, 2019 (JP) 2019-074186

(51) Int. Cl. H01M 10/0587; H01M 50/531; H01M 50/103; H01M 10/04; H01M 4/131; H01M 50/449; H01M 4/70

(52) U.S. Cl. CPC H01M 10/0587; H01M 50/531; H01M 50/103; H01M 4/70; H01M 4/131; H01M 50/449; H01M 10/0431

(57) ABSTRACT

A battery is provided. The battery includes an electrode body having a winding structure. The electrode body includes a first electrode having a first belt shape, a second electrode having a second belt shape, and a separator having a third belt shape, and an electrolyte. The separator is provided between the first electrode and the second electrode.

### CROSS REFERENCE TO RELATED APPLICATIONS

The present application is a continuation of PCT patent application no. PCT/JP2020/015213, filed on Apr. 2, 2020, which claims priority to Japanese patent application no. JP2019-074186 filed on Apr. 9, 2019, the entire contents of which are being incorporated herein by reference.

### BACKGROUND

The present disclosure generally relates to a battery.

In recent years, a battery having a winding structure in which a positive electrode and a negative electrode that have a belt shape are wound with a separator having a belt shape therebetween has been widely used. A battery having this winding structure includes an insulating member (an insulating tape) in order to avoid electrical contact between a positive-electrode-current-collector exposed part and a negative-electrode-current-collector exposed part.

### SUMMARY

The present disclosure generally relates to a battery.

However, the conventional battery has a problem in which the stability of insertion of a positive electrode is low at the beginning of winding of the positive electrode, and therefore a failure in winding occurs.

It is an object of the present disclosure to provide a battery that can avoid the occurrence of a failure in winding.

In order to solve the problem described above, the present disclosure provides a battery including:

an electrode body having a winding structure, the electrode body including:

a first electrode having a first belt shape;

a second electrode having a second belt shape; and

a separator having a third belt shape, the separator being provided between the first electrode and the second electrode; and

an electrolyte, in which

an electrode that is located at an innermost periphery from among the first electrode and the second electrode includes:

a current collector that includes a first principal face and a second principal face;

a first active material layer that is provided on the first principal face in such a way that a first current-collector exposed part is provided at an end on a winding center side of the electrode;

a second active material layer that is provided on the second principal face in such a way that a second current-collector exposed part is provided at the end on the winding center side of the electrode;

a first insulating member; and

a second insulating member,

the first insulating member covers a boundary between the first active material layer and the first current-collector exposed part, and the first current-collector exposed part,

the second insulating member covers a boundary between the second active material layer and the second current-collector exposed part, and the second current-collector exposed part,

the first insulating member and the second insulating member overlap each other to sandwich the current collector,

widths of the first insulating member and the second insulating member in a shorter side direction of the electrode are greater than a width of the electrode in the shorter side direction of the electrode,

the second insulating member is located on the second principal face between the end on the winding center side of the electrode and an end of the first active material layer, and

the first insulating member is located on the first principal face between the end on the winding center side of the electrode and an end of the second active material layer.

According to the present, the occurrence of a failure in winding can be avoided.

It should be understood that the effects described in the present specification are only examples, which do not impose limitations, and additional effects may be further provided.

### BRIEF DESCRIPTION OF THE FIGURES

FIG. 1 is an exploded perspective view illustrating an example of a configuration of a nonaqueous electrolyte secondary battery according to an embodiment of the present disclosure.

FIG. 2 is a sectional view along line U-II in FIG. 1.

FIG. 3A is a developed view illustrating an example of a configuration of an end on a winding center side of a positive electrode according to an embodiment of the present disclosure.

FIG. 3B is a sectional view along line IIIB-IIIB in FIG. 3A.

FIG. 4 is a schematic diagram illustrating an example of a configuration of a winding device according to an embodiment of the present disclosure.

FIG. 5 is a block diagram illustrating an example of a configuration of an electronic device according to an embodiment of the present disclosure.

FIG. 6A, FIG. 6B, FIG. 6C, and FIG. 6D are respectively developed views illustrating a configuration example of an end on a winding center side of a positive electrode in variations according to an embodiment of the present disclosure. FIG. 6E is a developed view illustrating a configuration of an end on a winding center side of a positive electrode in Comparative Example 1.

### DETAILED DESCRIPTION

As described herein, the present disclosure will be described based on examples with reference to the drawings, but the present disclosure is not to be considered limited to the examples, and various numerical values and materials in the examples are considered by way of example.

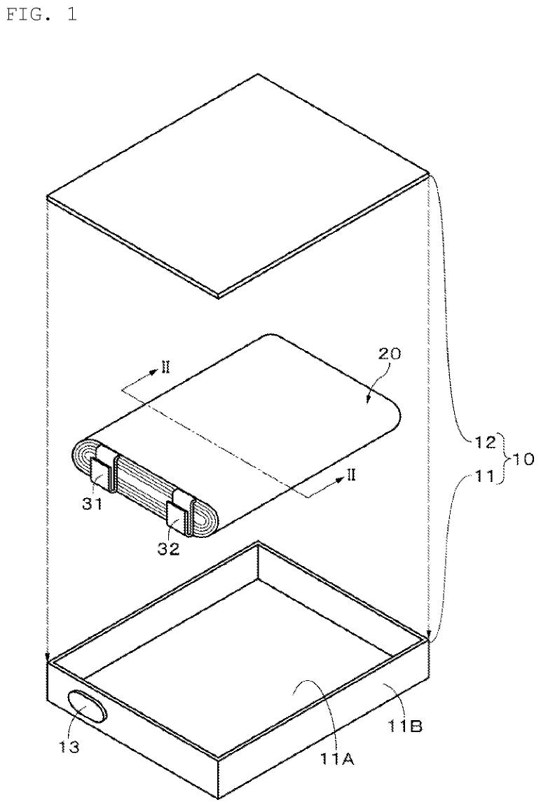

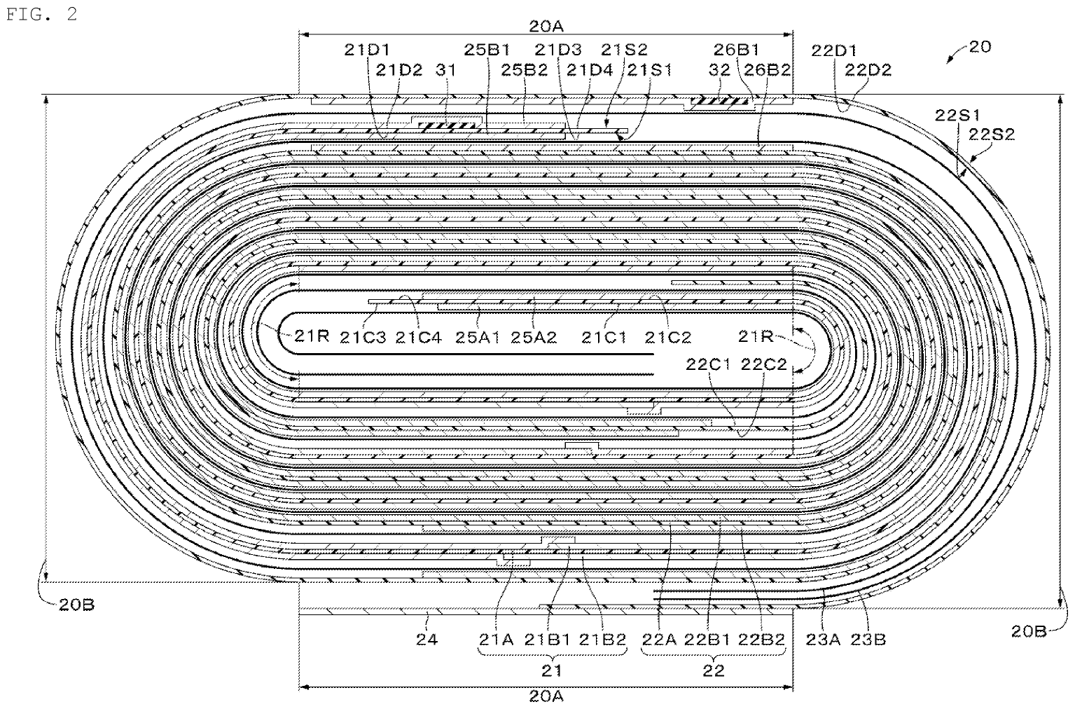

First, an example of a configuration of a nonaqueous electrolyte secondary battery (hereinafter simply referred to as a “battery”) according to a first embodiment of the present disclosure is described with reference to FIG. 1 and FIG. 2. The battery has a flat shape, as illustrated in FIG. 1. The battery includes an electrode body 20 of a winding type that a positive electrode tab 31 and a negative electrode tab 32 are attached to, and has a flat shape, an electrolyte solution (not illustrated) that serves as an electrolyte, and a case 10 that houses the electrode body 20 and the electrolyte solution that have been described above. In a plan view of the battery from a direction perpendicular to a principal face of the battery, the battery has a rectangular shape.

The case 10 is a thin battery can having a cuboid shape, and includes, for example, iron (Fe) plated with nickel (Ni). The case 10 includes a housing 11 and a lid 12. The housing 11 houses the electrode body 20. The housing 11 includes a principal face part 11A, and a wall 11B that is provided at a periphery of the principal face part 11A. The principal face part 11A covers a principal face of the electrode body 20, and the wall 11B covers a side face and an end face of the electrode body 20. In the wall 11B, a positive electrode terminal 13 is provided in a portion that faces one end face (an end face on a side from which the positive electrode tab 31 and the negative electrode tab 32 are extended) of the electrode body 20. The positive electrode tab 31 is connected to the positive electrode terminal 13. The negative electrode tab 32 is connected to an inside face of the case 10. The lid 12 covers a cavity of the housing 11. A top of the wall 11B of the housing 11 and a periphery of the lid 12 are joined by welding, an adhesive, or the like.

Each of the positive electrode tab 31 and the negative electrode tab 32 includes, for example, a metallic material such as Al, Cu, Ni, or stainless steel, and has a thin plate shape or the like.

As illustrated in FIG. 2, the electrode body 20 includes a pair of flat parts 20A that face each other, and a pair of curved parts 20B that are provided between this pair of flat parts 20A and face each other. The electrode Body 20 includes a positive electrode 21 having a belt shape, a negative electrode 22 having a belt shape, two separators 23A and 23B having a belt shape, insulating members 25A1, 25A2, 25B1, and 25B2 that are provided on the positive electrode 21, and insulating members 26B1 and 26B2 that are provided on the negative electrode 22.

The separators 23A and 23B are alternately provided between the positive electrode 21 and the negative electrode 22. The electrode body 20 has a configuration in which the positive electrode 21 and the negative electrode 22 are laminated with the separator 23A or the separator 23B interposed therebetween, and are wound in a longitudinal direction to have a flat shape and a spiral shape. The electrode body 20 is wound in such a way that the positive electrode 21 serves as an innermost peripheral electrode and the negative electrode 22 serves as an outermost peripheral electrode. The negative electrode 22 serving as the outermost peripheral electrode is fixed by using a winding stop tape 24. The positive electrode 21, the negative electrode 22, and the separators 23A and 23B are impregnated with an electrolyte solution. In the first embodiment, the positive electrode 21 corresponds to a specific example of a “first electrode” of the present disclosure, and the negative electrode 22 corresponds to a specific example of a “second electrode” of the present disclosure.

The positive electrode tab 31 and the negative electrode tab 32 are respectively provided on outermost peripheral sides of the positive electrode 21 and the negative electrode 22. By employing such a configuration, flatness of the flat part 20A can be improved in comparison with a case where the positive electrode tab 31 and the negative electrode tab 32 are respectively provided on innermost peripheral sides of the positive electrode 21 and the negative electrode 22. Accordingly, a gap can be prevented from being generated between the case 10 and the electrode body 20. Accordingly, volume energy density of the battery can be improved.

The positive electrode 21 includes a positive electrode current collector 21A including an inside face (a first face) 21S1 and an outside face (a second face) 21S2, a positive electrode active material layer 21B1 that is provided on the inside face 21S1 of the positive electrode current collector 21A, and a positive electrode active material layer 21B2 that is provided on the outside face 21S2 of the positive electrode current collector 21A. Herein, an “inside face” means a face that is located on a side of a winding center, and an “outside face” means a face that is located on a side opposite to the winding center.

The inside face 21S1 at an end on the winding center side (hereinafter simply referred to as a “center-side end”) of the positive electrode 21 is provided with a positive-electrode-current-collector exposed part 21C1 in which the positive electrode active material layer 21B1 is not provided, and the inside face 21S1 of the positive electrode current collector 21A is exposed. The outside face 21S2 at the center-side end of the positive electrode 21 is provided with a positive-electrode-current-collector exposed part 21C2 in which the positive electrode active material layer 21B1 is not provided, and the outside face of the positive electrode current collector 21A is exposed. A length in a winding direction of the positive-electrode-current-collector exposed part 21C1 is, for example, greater than a length in the winding direction of the positive-electrode-current-collector exposed part 21C2 by about one round. Stated another way, the positive electrode 21 is provided with a single-sided electrode part in which only the positive electrode active material layer 21B2 of the positive electrode active material layer 21B1 and the positive electrode active material layer 21B2 is provided in the positive electrode current collector 21A, for example, by about one round. The positive-electrode-current-collector exposed part 21C1 corresponds to a specific example of a “first current-collector exposed part” of the present disclosure, and the positive-electrode-current-collector exposed part 21C2 corresponds to a specific example of a “second current-collector exposed part” of the present disclosure.

The inside face 21S1 at an end on a winding outer peripheral side (hereinafter simply referred to as an “outer-peripheral-side end”) of the positive electrode 21 is provided with a positive-electrode-current-collector exposed part 21D1 in which the positive electrode active material layer 21B1 is not provided, and the inside face 21S1 of the positive electrode current collector 21A is exposed. The outside face 21S2 at the outer-peripheral-side end of the positive electrode 21 is provided with a positive-electrode-current-collector exposed part 21D2 in which the positive electrode active material layer 21B2 is not provided, and the outside face 21S2 of the positive electrode current collector 21A is exposed. A portion that corresponds to the flat part 20A in the positive-electrode-current-collector exposed part 21D2 is connected to the positive electrode tab 31. A length in the winding direction of the positive-electrode-current-collector exposed part 21D1 is, for example, roughly the same as a length in the winding direction of the positive-electrode-current-collector exposed part 21D2. A length of the positive-electrode-current-collector exposed part 21C1, 21C2, 21D1, or 21D2 in the winding direction means a length of the positive-electrode-current-collector exposed part 21C1, 21C2, 21D1, or 21D2 in a longitudinal direction in a case where the electrode body 20 is released.

Herein, the center-side end of the positive electrode 21 means a portion that includes an end (a distal end) on the winding center side of the positive electrode 21, a center-side end of the inside face of the positive electrode 21, and a center-side end of the outside face of the positive electrode 21. The outer-peripheral-side end of the positive electrode 21 means a portion that includes an end (a distal end) on the winding outer peripheral side of the positive electrode 21, an outer-peripheral-side end of the inside face of the positive electrode 21, and an outer-peripheral-side end of the outside face of the positive electrode 21.

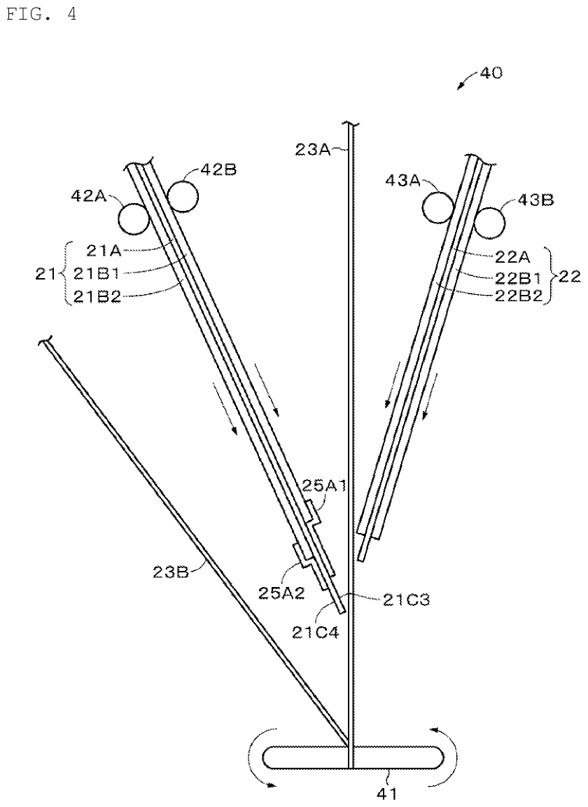

The positive electrode current collector 21A includes, for example, metallic foil such as aluminum foil, nickel foil, or stainless foil. It is preferable that a width We of the positive electrode current collector 21A range from 5 mm to 25 mm inclusive. If the width We of the positive electrode current collector 21A is 5 mm or more, the rigidity of the center-side end of the positive electrode 21 can be increased, and therefore the stability of insertion of the positive electrode 21 at the time of winding can be improved. Specifically, when the center-side end of the positive electrode 21 is inserted between the two separators 23A and 23B at the time of winding (see FIG. 4), the center-side end of the positive electrode 21 can be prevented from being curved, and can be prevented from being inserted between the two separators 23A and 23B in a bent state or the like. Accordingly, the occurrence of a failure in winding (winding misalignment) can be avoided. On the other hand, if the width W_{c} of the positive electrode current collector 21A is 25 mm or less, a size of the battery can be reduced in comparison with a conventional battery.

It is preferable that a thickness T_{c} of the positive electrode current collector 21A range from 5 μm to 15 μm inclusive. If the thickness T_{c} of the positive electrode current collector 21A is 5 μm or more, the rigidity of the center-side end of the positive electrode 21 can be increased, and therefore an effect that is similar to an effect in a case where the width W_{c} of the positive electrode current collector 21A is 5 mm or more can be exhibited. On the other hand, if the thickness T_{c} of the positive electrode current collector 21A is 15 μm or less, a reduction in energy density of the battery can be avoided.

The positive electrode 21 includes, at the center-side end, a single-sided electrode part in which the inside face 21S1 is exposed so that the positive-electrode-current-collector exposed part 21C1 is formed, and the positive electrode active material layer 21B2 is formed on the outside face 21S2. This single-sided electrode part includes a curved part. A region 21R that corresponds to the curved part of the single-sided electrode part in the positive-electrode-current-collector exposed part 21C1 is covered with the insulating member 25A1. By doing this, in a process of pressing the battery, the insulating member 25A1 can support the curved part of the single-sided electrode part from a side of the inside face 21S1 of the positive electrode current collector 21A. Accordingly, in the process of pressing the battery, stress applied to the curved part of the single-sided electrode part can be reduced. Thus, the occurrence of a minute short circuit failure can be avoided.

The positive electrode active material layers 21B1 and 21B2 include a positive electrode active material that can occlude and release lithium. The positive electrode active material layers 21B and 21B2 may further include at least one of binder and a conductive agent, as needed.

Any positive electrode active material that can occlude and release Li can be employed. An appropriate example is a lithium-containing compound such as lithium oxide, lithium phosphorus oxide, lithium sulfide, or an intercalation compound containing lithium, and a mixture of two or more of them may be used. In order to increase energy density, a lithium-containing compound containing lithium, a transition metal element, and oxygen is preferable.

As the binder, for example, at least one selected from the group consisting of polyvinylidene fluoride, polytetrafluoroethylene, polyacrylonitrile, styrene-butadiene rubber, carboxymethyl cellulose, copolymer principally containing one of these resin materials, and the like can be used.

As the conductive agent, for example, at least one carbon material selected from the group consisting of graphite, carbon fiber, carbon black, acetylene black, Ketjen black, a carbon nanotube, graphene, and the like can be used.

The negative electrode 22 includes a negative electrode current collector 22A that includes an inside face (a first face) 22S1 and an outside face (a second face) 22S2, a negative electrode active material layer 22B1 that is provided on the inside face 22S1 of the negative electrode current collector 22A, and a negative electrode active material layer 22B2 that is provided on the outside face 22S2 of the negative electrode current collector 22A.

The inside face 22S1 at a center-side end of the negative electrode 22 is provided with a negative-electrode-current-collector exposed part 22C1 in which the negative electrode active material layer 22B1 is not provided, and the inside face 22S1 of the positive electrode current collector 21A is exposed. The outside face 22S2 at the center-side end of the negative electrode 22 is provided with a negative-electrode-current-collector exposed part 22C2 in which the negative electrode active material layer 22B2 is not provided, and the outside face of the negative electrode current collector 22A is exposed. A length in the winding direction of the negative-electrode-current-collector exposed part 22C1 is, for example, roughly the same as a length in the winding direction of the negative-electrode-current-collector exposed part 22C2.

The inside face 22S1 at an outer-peripheral-side end of the negative electrode 22 is provided with a negative-electrode-current-collector exposed part 22D1 in which the negative electrode active material layer 22B1 is not provided, and the inside face 22S1 of the positive electrode current collector 21A is exposed. The outside face 22S2 at the outer-peripheral-side end of the negative electrode 22 is provided with a negative-electrode-current-collector exposed part 22D2 in which the negative electrode active material layer 22B2 is not provided, and the outside face 22S2 of the negative electrode current collector 22A is exposed. A portion that corresponds to the flat part 20A in the negative-electrode-current-collector exposed part 22D1 is connected to the negative electrode tab 32. Note that the positive electrode tab 31 and the negative electrode tab 32 are provided on a side of the same flat part 20A.

Herein, the center-side end and the outer-peripheral-side end of the negative electrode 22 are used in a meaning that is similar to a meaning of the center-side end and the outer-peripheral-side end of the positive electrode 21.

A length in the winding direction of the negative-electrode-current-collector exposed part 22D1 is greater than a length in the winding direction of the negative-electrode-current-collector exposed part 22D2 by about one round. Stated another way, the negative electrode 22 is provided with a single-sided electrode part in which only the negative electrode active material layer 22B1 of the negative electrode active material layer 22B1 and the negative electrode active material layer 22B2 is provided in the negative electrode current collector 22A, for example, by about one round. A length of the negative-electrode-current-collector exposed part 22C1, 22C2, 22D1, or 22D2 in the winding direction means a length of the negative-electrode-current-collector exposed part 22C1, 22C2, 22D1, or 22D2 in a longitudinal direction in a case where the electrode body 20 is released.

An outermost periphery of the negative electrode 22 is provided with a portion where both the inside face 22S1 and the outside face 22S2 of the negative electrode current collector 22A are exposed (that is, a portion where the negative-electrode-current-collector exposed part 22D1 and the negative-electrode-current-collector exposed part 22D2 are provided on both sides of the positive electrode 21), for example, by about one round. This causes the negative-electrode-current-collector exposed part 22D2 and an inside face of the case 10 to be in electrical contact with each other. Accordingly, resistance between the negative electrode 22 and the case 10 can be reduced.

The negative electrode current collector 22A includes, for example, metallic foil such as copper foil, nickel foil, or stainless foil. The negative electrode active material layers 22B1 and 22B2 include a negative electrode active material that can occlude and release lithium. The negative electrode active material layers 22B1 and 22B2 may further include at least one of binder and a conductive agent, as needed.

Any negative electrode active material that can occlude and release Li can be employed. An example is a carbon material such as non-graphitizable carbon, highly graphitizable carbon, graphite, pyrolytic carbon, coke, vitreous carbon, an organic polymer compound fired body, carbon fiber, or activated carbon. Among the above, examples of coke include pitch coke, needle coke, petroleum coke, and the like. The organic polymer compound fired body is a material obtained by firing and carbonizing a polymer material, such as phenol resin or furan resin, at an appropriate temperature, and some organic polymer compound fired bodies are classified as non-graphitizable carbon or highly graphitizable carbon. These carbon materials are preferable, because a change in a crystal structure at the time of charging/discharging is very small, a high charging/discharging capacity can be obtained, and satisfactory cycle characteristics can be obtained. In particular, graphite is preferable, because an electrochemical equivalent is large, and a high energy density can be obtained. Furthermore, non-graphitizable carbon is preferable, because satisfactory cycle characteristics can be obtained. Moreover, a material having a low charging/discharging potential and specifically, a material having a charging/discharging potential that is similar to a charging/discharging potential of lithium metal are preferable, because an increase in energy density in a battery can be achieved.

As the binder, a material that is similar to a material in the positive electrode active material layer 21B1 or 21B2 can be used.

As the conductive agent, a material that is similar to a material in the positive electrode active material layer 21B1 or 21B2 can be used.

The separators 23A and 23B separate the positive electrode 21 and the negative electrode 22, avoid a short circuit of a current due to contact between both electrodes, and cause lithium ion to pass. The separators 23A and 23B include, for example, a porous membrane that includes polytetrafluoroethylene, polyolefin resin (polypropylene (PP), polyethylene (PE), or the like), acrylic resin, styrene resin, polyester resin, or nylon resin, or resin obtained by blending these types of resin, and may have a configuration in which two or more of these porous membranes are laminated.

The electrolyte solution is what is called a nonaqueous electrolyte solution, and includes an organic solvent (a nonaqueous solvent) and electrolyte salt dissolved in this organic solvent. The electrolyte solution may include publicly known additives in order to improve battery characteristics. Note that instead of the electrolyte solution, an electrolyte layer that includes the electrolyte solution and a polymer compound serving as a holder that holds this electrolyte solution may be used. In this case, the electrolyte layer may be gelatinous.

As the organic solvent, cyclic carbonic acid ester, such as ethylene carbonate or propylene carbonate, can be used. It is preferable that one of ethylene carbonate and propylene carbonate, and in particular, a mixture of both be used. This is because cycle characteristics can be further improved.

Furthermore, it is preferable that as the organic solvent, a mixture of these types of cyclic carbonic acid ester and chain carbonic acid ester, such as diethyl carbonate, dimethyl carbonate, ethyl methyl carbonate, or methylpropyl carbonate, be used. This is because high ion conductivity can be obtained.

Moreover, it is preferable that the organic solvent include 2,4-difluoroanisole or vinylene carbonate. This is because 2,4-difluoroanisole can further improve a charging/discharging capacity, and vinylene carbonate can further improve cycle characteristics. Therefore, it is preferable that a mixture of these be used, because the charging/discharging capacity and the cycle characteristics can be further improved.

An example of electrolyte salt is lithium salt, and a single type of lithium salt may be used, or a mixture of two or more types of lithium salt may be used. Examples of lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, difluoro[oxalato-O,O′] lithium borate, lithium bis-oxalate borate, LiBr, and the like. Among the above, LiPF₆ is preferable, because high ion conductivity can be obtained, and cycle characteristics can be further improved.

The insulating members 25A1, 25A2, 25B1, 25B2, 26B1, and 26B2 have, for example, a rectangular film shape, and have an adhesive surface on one face. More specifically, the insulating members 25A1, 25A2, 25B1, 25B2, 26B1, and 26B2 include a substrate and an adhesive layer that is provided on the substrate. Note that herein, pressure sensitive adhesion is defined as one type of adhesion. According to this definition, a pressure sensitive adhesive layer is regarded as one type of an adhesive layer.

Furthermore, it is defined that a film also includes a sheet. As the insulating members 25A1, 25A2, 25B1, 25B2, 26B1, and 26B2, for example, an insulating tape is used.

Widths of the insulating members 25A1 and 25A2 in a shorter side direction of the positive electrode 21 are the same as each other, and are greater than a width of the positive electrode current collector 21A in the shorter side direction of the positive electrode 21. The insulating members 25A1 and 25A2 are respectively provided in the positive-electrode-current-collector exposed parts 21C1 and 21C2 in such a way that both sides protrude from sides of both longer sides of the positive electrode current collector 21A. The insulating members 25A 1 and 25A2 overlap each other to sandwich the positive electrode current collector 21A. By superimposing the insulating members 25A1 and 25A2 onto each other, as described above, the rigidity of the center-side end of the positive electrode 21 can be increased, and therefore the stability of insertion of the positive electrode 21 at the time of winding can be improved. The insulating member 25A1 corresponds to a specific example of a “first insulating member” of the present disclosure, and the insulating member 25A2 corresponds to a specific example of a “second insulating member” of the present disclosure.

Widths of the insulating members 25B1 and 25B2 in the shorter side direction of the positive electrode 21 are the same as each other, and are greater than the width of the positive electrode current collector 21A in the shorter side direction of the positive electrode 21. The insulating members 25B1 and 25B2 are respectively provided in the positive-electrode-current-collector exposed parts 21D1 and 21D2 in such a way that both sides protrude from sides of both longer sides of the positive electrode current collector 21A. The insulating members 25B1 and 25B2 overlap each other to sandwich the positive electrode current collector 21A.

The insulating member 25A1 covers a difference in level at a boundary between the positive-electrode-current-collector exposed part 21C1 and the positive electrode active material layer 21B1, and the positive-electrode-current-collector exposed part 21C1.

The insulating member 25A2 covers a difference in level at a boundary between the positive-electrode-current-collector exposed part 21C2 and the positive electrode active material layer 21B2, and the positive-electrode-current-collector exposed part 21C2.

The insulating member 25A1 is provided in a region where the positive-electrode-current-collector exposed part 21C1 and the negative electrode active material layer 22B2 face each other and a region where the positive-electrode-current-collector exposed part 21C1 and the negative-electrode-current-collector exposed part 22C2 face each other. The insulating member 25A2 is provided in a region where the positive-electrode-current-collector exposed part 21C2 and the negative electrode active material layer 22B1 face each other and a region where the positive-electrode-current-collector exposed part 21C2 and the negative-electrode-current-collector exposed part 22C1 face each other.

The insulating member 25A1 is located on the inside face 21S1 between an end on the winding center side of the positive electrode 21 and an end on the winding center side of the positive electrode active material layer 21B2. Stated another way, an end on the winding center side of the insulating member 25A1 is located in a section between the end on the winding center side of the positive electrode 21 and the end on the winding center side of the positive electrode active material layer 21B2. The insulating member 25A2 is located on the outside face 21S2 between the end on the winding center side of the positive electrode 21 and an end on the winding center side of the positive electrode active material layer 21B1. Stated another way, an end on the winding center side of the insulating member 25A2 is located in a section between the end on the winding center side of the positive electrode 21 and the end on the winding center side of the positive electrode active material layer 21B1.

The positive electrode 21 includes a positive-electrode-current-collector exposed part 21C3 in which a center-side end of the positive-electrode-current-collector exposed part 21C1 is not covered with the insulating member 25A 1 and is exposed, and a positive-electrode-current-collector exposed part 21C4 in which a center-side end of the positive-electrode-current-collector exposed part 21C2 is not covered with the insulating member 25A2 and is exposed.

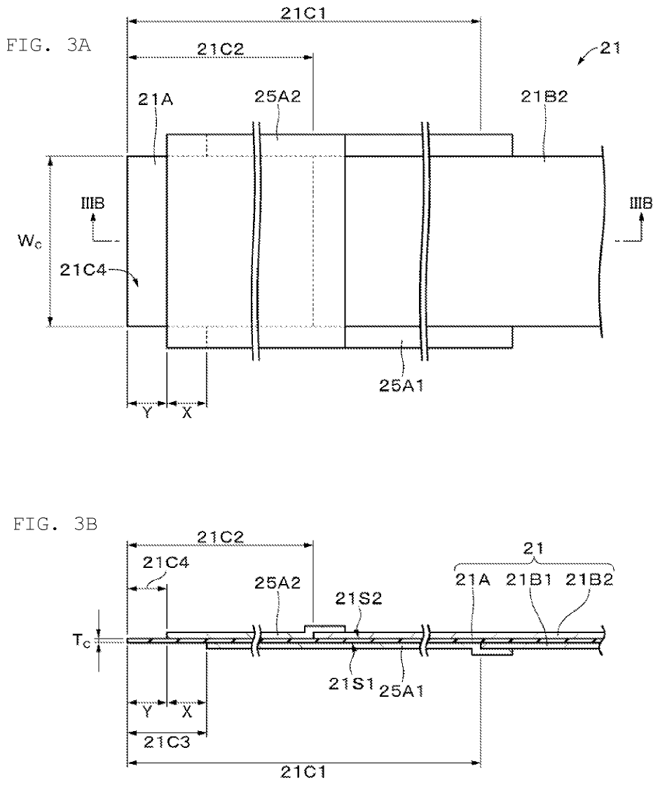

FIG. 3A and FIG. 3B are developed views illustrating an example of a configuration of the center-side end of the positive electrode 21. Ends (distal ends) on the winding center side of the insulating member 25A 1 and the insulating member 25A2 are misaligned. A length in the winding direction of the positive-electrode-current-collector exposed part 21C3 is greater than a length in the winding direction of the positive-electrode-current-collector exposed part 21C4. The lengths in the winding direction of the positive-electrode-current-collector exposed parts 21C3 and 21C4 mean lengths in the longitudinal direction of the positive-electrode-current-collector exposed part 21C3 and 21C4 in a case where the electrode body 20 is released.

Stated another way, in a state where the electrode body 20 is released, a distance from an end on the winding center side of the positive electrode 21 to an end on the winding center side of the insulating member 25A1 in the longitudinal direction is longer than a distance from the end on the winding center side of the positive electrode 21 to an end on the winding center side of the insulating member 25A2 in the longitudinal direction.

An amount of misalignment X of the ends (distal ends) on the winding center side of the insulating member 25A1 and the insulating member 25A2 is 3.0 mm or less, preferably 2.0 mm or less, and more preferably 1.0 mm or less. If the amount of misalignment X of the ends (the distal ends) on the winding center side is 3.0 mm or less, an area of the adhesive surface of the insulating member 25A1 or the insulating member 25A2 that is exposed from sides of both longer sides of the positive electrode 21 can be reduced. This can avoid a situation in which, when the center-side end of the positive electrode 21 is inserted between the two separators 23A and 23B at the time of winding (see FIG. 4), the adhesive surface of the insulating member 25A1 or the insulating member 25A2 that is exposed from the sides of both longer sides of the positive electrode 21 is stuck onto the separator 23A or the separator 23B, and the center-side end of the positive electrode 21 is bent, for example. Accordingly, the stability of insertion of the positive electrode 21 at the time of winding can be improved, and the occurrence of a failure in winding (winding misalignment) can be avoided.

A length Y of a portion where the positive-electrode-current-collector exposed part 21C3 and the positive-electrode-current-collector exposed part 21C4 overlap each other in a thickness direction of the positive electrode 21 (hereinafter simply referred to as a “length Y of a both-sided current-collector exposed part”) is preferably 5 mm or less, more preferably 4 mm or less, and yet more preferably 3 mm or less. If the length Y of the both-sided current-collector exposed part is 5 mm or less, the rigidity of the center-side end of the positive electrode 21 can be increased, and therefore the stability of insertion of the positive electrode 21 at the time of winding can be improved. Specifically, when the center-side end of the positive electrode 21 is inserted between the two separators 23A and 23B at the time of winding (see FIG. 4), the center-side end of the positive electrode 21 can be prevented from being curved and being inserted between the two separators 23A and 23B in a bent state or the like. Accordingly, the occurrence of a failure in winding (winding misalignment) can be avoided.

The insulating member 25B1 covers a difference in level at a boundary between the positive-electrode-current-collector exposed part 21D1 and the positive electrode active material layer 21B1, and the positive-electrode-current-collector exposed part 21D1.

The insulating member 25B2 covers a difference in level at a boundary between the positive-electrode-current-collector exposed part 21D2 and the positive electrode active material layer 21B2, and the positive-electrode-current-collector exposed part 21D2. Note that the insulating member 25B2 also covers the positive electrode tab 31 together with the positive-electrode-current-collector exposed part 21D2.

The insulating member 25B1 is provided in a region where the positive-electrode-current-collector exposed part 21D1 and the negative electrode active material layer 22B2 face each other and a region where the positive-electrode-current-collector exposed part 21D1 and the negative-electrode-current-collector exposed part 22D2 face each other. The insulating member 25B2 is provided in a region where the positive-electrode-current-collector exposed part 21D2 and the negative electrode active material layer 22B2 face each other and a region where the positive-electrode-current-collector exposed part 21D2 and the negative-electrode-current-collector exposed part 22D1 face each other.

The positive electrode 21 includes a positive-electrode-current-collector exposed part 21D3 in which an outer-peripheral-side end of the positive-electrode-current-collector exposed part 21D1 is not covered with the insulating member 25B1 and is exposed, and a positive-electrode-current-collector exposed part 21D4 in which an outer-peripheral-side end of the positive-electrode-current-collector exposed part 21D2 is not covered with the insulating member 25B2 and is exposed.

The Insulating member 26B1 covers a portion that is provided with the negative electrode tab 32 and a portion that faces the positive-electrode-current-collector exposed part 21D4 in the negative-electrode-current-collector exposed part 22D1. The insulating member 26B1 may cover almost the entirety of a portion that corresponds to one flat part 20A in the negative-electrode-current-collector exposed part 22D1.

The Insulating member 26B2 covers a portion that faces the negative electrode tab 32 and a portion that faces the positive-electrode-current-collector exposed part 21D3 in the negative-electrode-current-collector exposed part 22D2. The insulating member 26B2 may cover almost the entirety of a portion that corresponds to one flat part 20A in the negative-electrode-current-collector exposed part 22D1.

Next, an example of a configuration of a winding device 40 that makes the electrode body 20 having the configuration described above is described with reference to FIG. 4. The winding device 40 includes a winding core 41, a pair of nip rollers 42A and 42B, a pair of nip rollers 43A and 43B, a cutter (not illustrated), and a control device (not illustrated). The winding core 41 has a flat shape, and can hold one ends of the two separators 23A and 23B. The winding core 41 is rotatable, and winds the positive electrode 21, the negative electrode 22, and the separators 23A and 23B. The pair of nip rollers 42A and 42B can nip the positive electrode 21. The pair of nip rollers 43A and 43B can nip the negative electrode 22. The cutter cuts the positive electrode 21, the negative electrode 22, and the separators 23A and 23B. The control device controls the entirety of the winding device 40.

Next, an example of a method for manufacturing a battery according to the first embodiment of the present disclosure is described.

The positive electrode 21 is made as the following. First, for example, a positive electrode active material, binder, and a conductive agent are mixed so that a positive electrode mixture is prepared, this positive electrode mixture is dispersed in a solvent such as N-methyl-2-pyrrolidone (NMP), and a pasty positive electrode mixture slurry is made. Next, this positive electrode mixture slurry is applied to both faces of the positive electrode current collector 21A, the solvent is dried, and compression molding is performed by using a roll press machine or the like. Therefore, the positive electrode active material layers 21B1 and 21B2 are formed, and the positive electrode 21 is obtained. At this time, a position of application of the positive electrode mixture slurry is adjusted in such a way that the positive-electrode-current-collector exposed parts 21C1 and 21C2 are formed at one end of the positive electrode 21, and the positive-electrode-current-collector exposed parts 21D1 and 21D2 are formed at another end of the positive electrode 21.

Next, the positive electrode tab 31 is attached, by welding, to the positive-electrode-current-collector exposed part 21D2 that is provided at the other end of the positive electrode 21. Next, the insulating members 25A1 and 25A2 are respectively stuck onto the positive-electrode-current-collector exposed parts 21C1 and 21C2 that are provided on the one end of the positive electrode 21, and the insulating members 25B1 and 25B2 are respectively stuck onto the positive-electrode-current-collector exposed parts 21D1 and 21D2 that are provided at the other end of the positive electrode 21.

The negative electrode 22 is made as the following. First, for example, a negative electrode active material and binder are mixed so that a negative electrode mixture is prepared, this negative electrode mixture is dispersed in a solvent such as N-methyl-2-pyrrolidone, and a pasty negative electrode mixture slurry is made. Next, this negative electrode mixture slurry is applied to both faces of the negative electrode current collector 22A, the solvent is dried, and compression molding is performed by using a roll press machine or the like. Therefore, the negative electrode active material layers 22B1 and 22B2 are formed, and the negative electrode 22 is obtained. At this time, a position of application of the negative electrode mixture slurry is adjusted in such a way that the negative-electrode-current-collector exposed parts 22C1 and 22C2 are formed at one end of the negative electrode 22, and the negative-electrode-current-collector exposed parts 22D1 and 22D2 are formed at another end of the negative electrode 22.

Next, the negative electrode tab 32 is attached, by welding, to the negative-electrode-current-collector exposed part 22D1 that is provided at the other end of the negative electrode 22. Next, the insulating members 26B1 and 26B2 are respectively stuck onto the positive-electrode-current-collector exposed parts 21D1 and 21D2 that are provided at the other end of the negative electrode 22.

The electrode body 20 of a winding type is made as the following, by using the winding device 40 described above. First, when an operator operates the control device to start a winding operation, the winding device 40 conveys the two separators 23A and 23B toward the winding core 41, chucks respective one ends of the two separators 23A and 23B by using the winding core 41, and holds the two separators 23A and 23B in a V-shape. Next, the winding device 40 disposes the positive electrode 21 in a predetermined position with the nip rollers 42A and 42B therebetween.

Next, the winding device 40 rotates the winding core 41, and winds the two separators 23A and 23B onto the winding core 41. When the two separators 23A and 23B have been wound by a specified amount, the winding device 40 inserts one end of the positive electrode 21 between the two separators 23A and 23B that is held in the V-shape, and winds the positive electrode 21 by using the winding core 41. At this time, if an amount of misalignment X of ends (distal ends) on the winding center side of the insulating member 25A1 and the insulating member 25A2 is 3.0 mm or less, as described above, a situation can be avoided where the adhesive surface of the insulating member 25A1 or the insulating member 25A2 that is exposed from the sides of both longer sides of the positive electrode 21 is stuck onto the separator 23A or the separator 23B, and an end of the positive electrode 21 is bent, for example.

Next, the winding device 40 inserts the negative electrode 22 between the two wound separators 23A and 23B along the separator 23A, and winds the negative electrode 22 by using the winding core 41. Then, when the positive electrode 21, the negative electrode 22, and the separators 23A and 23B have been wound by a specified amount by using the winding core 41, the positive electrode 21, the negative electrode 22, and the separators 23A and 23B are cut by using the cutter. By doing this, the electrode body 20 can be obtained.

The electrode body 20 is sealed with the case 10, as the following. First, the electrode body 20 and the electrolyte solution are housed in the housing 11 of the housing 11. At this time, the positive electrode tab 31 is connected to the positive electrode terminal 13 that is provided in the housing 11, and the negative electrode tab 32 is connected to the inside face of the case 10. Next, the cavity of the housing 11 is covered with the lid 12, the housing 11 and a periphery of the lid 12 are joined by welding, an adhesive, or the like, and the electrode body 20 is sealed with the case 10. By doing this, a battery can be obtained. Next, the battery may be molded by heat pressing, as needed.

In a battery according to the first embodiment, the insulating members 25A1 and 25A2 that are provided at the center-side end of the positive electrode 21 overlap each other to sandwich the positive electrode current collector 21A. An end on the winding center side of the insulating member 25A1 is located in a section between an end on the winding center side of the positive electrode 21 and an end on the winding center side of the positive electrode active material layer 21B2. Furthermore, an end on the winding center side of the insulating member 25A2 is located in a section between the end on the winding center side of the positive electrode 21 and an end on the winding center side of the positive electrode active material layer 21B1. By doing this, the rigidity of the center-side end of the positive electrode 21 can be increased. Furthermore, an area of an adhesive surface of the insulating member 25A1 or the insulating member 25A2 that is exposed from sides of both longer sides of the positive electrode 21 can be reduced. This can avoid a situation in which, when the center-side end of the positive electrode 21 is inserted between the two separators 23A and 23B at the time of winding (see FIG. 4), the adhesive surface of the insulating member 25A2 that is exposed from the sides of both longer sides of the positive electrode 21 is stuck onto the separator 23A, and the end of the positive electrode 21 is bent, for example. Accordingly, the stability of insertion of the positive electrode 21 at the time of winding can be improved, and the occurrence of a failure in winding (winding misalignment) can be avoided. Stated another way, the yield of the winding process can be improved.

In a second embodiment, an electronic device that includes a battery according to the first embodiment described above is described.

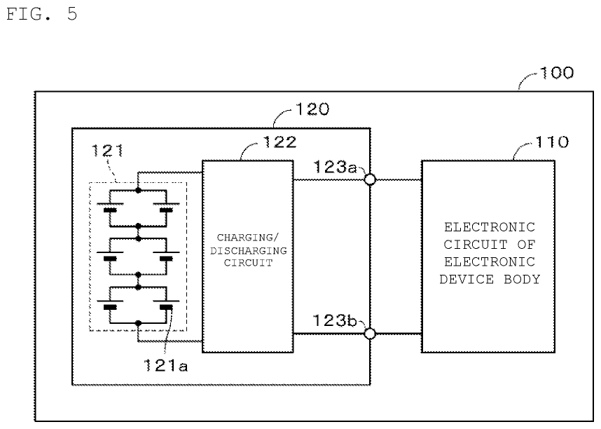

An example of a configuration of an electronic device 100 according to the second embodiment of the present disclosure is described below with reference to FIG. 5. An electronic device 100 includes an electronic circuit 110 of an electronic device body and a battery pack 120. The battery pack 120 is electrically connected to the electronic circuit 110 with a positive electrode terminal 123a and a negative electrode terminal 123b interposed therebetween. The electronic device 100 may have a configuration in which the battery pack 120 is attachable or detachable.

Examples of the electronic device 100 include laptop personal computers, tablet type computers, portable telephones (for example, smartphones or the like), portable information terminals (personal digital assistants: PDAs), display devices (liquid crystal displays (LCDs), electro luminescence (EL) displays, electronic paper, or the like), imaging devices (for example, digital still cameras, digital video cameras, or the like), audio devices (for example, portable audio players), game machines, codeless phone slave units, electronic books, electronic dictionaries, radios, headphones, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical instruments, robots, road conditioners, traffic lights, and the like, but these are not restrictive.

The electronic circuit 110 includes, for example, a central processing unit (CPU), a peripheral logic unit, an interface, a storage, or the like, and controls the entirety of the electronic device 100.

The battery pack 120 includes a packed battery 121 and a charging/discharging circuit 122. The battery pack 120 may further include an exterior material (not illustrated) that houses the packed battery 121 and the charging/discharging circuit 122, as needed.

The packed battery 121 has a configuration in which a plurality of secondary batteries 121a is connected in series and/or in parallel. The plurality of secondary batteries 121a is connected, for example, in the arrangement of n parallel strings of m in series (n and m are positive integers). Note that FIG. 5 illustrates an example in which six secondary batteries 121a are connected in the arrangement of 2 parallel strings of 3 in series (2P3S). As the secondary battery 121a, a battery according to the first embodiment described above is used.

Here, a case where the battery pack 120 includes the packed battery 121 that includes a plurality of secondary batteries 121a is described, but a configuration in which the battery pack 120 includes one secondary battery 121a instead of the packed battery 121 may be employed.

The charging/discharging circuit 122 is a control unit that controls charging/discharging of the packed battery 121. Specifically, at the time of charging, the charging/discharging circuit 122 controls charging of the packed battery 121. On the other hand, at the time of discharging (that is, when the electronic device 100 is used), the charging/discharging circuit 122 controls discharging of the electronic device 100.

As the exterior material, a case that includes, for example, metal, polymer resin, a composite material thereof, or the like can be used. An example of the composite material is a laminate in which a metal layer and a polymer resin layer have been laminated.

Embodiments of the present disclosure have been described in detail above, but the present disclosure is not limited to the embodiments described above, and various variations can be made on the basis of technical ideas of the present disclosure.

For example, configurations, methods, processes, shapes, materials, numerical values, and the like described in the embodiments described above are merely examples, and configurations, methods, processes, shapes, materials, numerical values, and the like that are different from these may be used, as needed. Furthermore, the configurations, the methods, the processes, the shapes, the materials, the numerical values, and the like in the embodiments described above can be combined with each other without departing from the gist of the present disclosure.

Furthermore, chemical formulae of compounds or the like that have been described as an example in the embodiments described above are representative examples, and valences or the like that have been described are not restrictive if generic terms of the same compounds are used.

Furthermore, in numerical value ranges described in stages in the embodiments described above, an upper limit value or a lower limit value of a numerical value range in a certain stage may be replaced with an upper limit value or a lower limit value of a numerical value range in another stage. Furthermore, from among the materials described as an example in the embodiments described above, only one or a combination of two or more can be used, unless otherwise specified.

In the embodiments described above, a case where a length in the winding direction of the positive-electrode-current-collector exposed part 21C3 is greater than a length in the winding direction of the positive-electrode-current-collector exposed part 21C4 has been described, but the present disclosure is not limited to this.

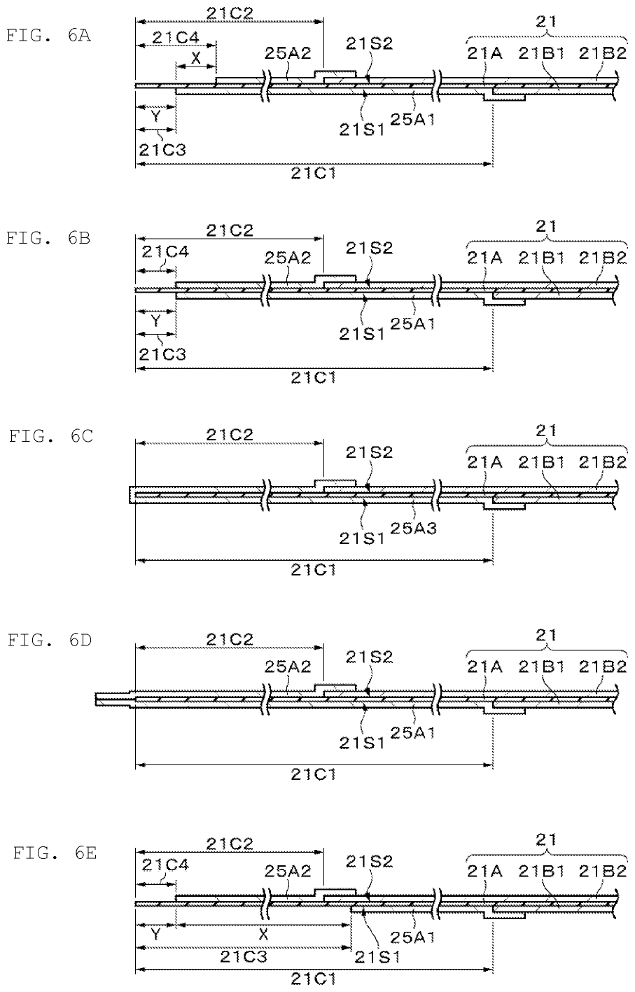

For example, as illustrated in FIG. 6A, a length in the winding direction of the positive-electrode-current-collector exposed part 21C4 may be greater than a length in the winding direction of the positive-electrode-current-collector exposed part 21C3. Stated another way, in a state where the electrode body 20 is released, a distance from an end on the winding center side of the positive electrode 21 to an end on the winding center side of the insulating member 25A2 in the longitudinal direction may be longer than a distance from the end on the winding center side of the positive electrode 21 to an end on the winding center side of the insulating member 25A1 in the longitudinal direction.

As illustrated in FIG. 6B, lengths in the winding direction of the positive-electrode-current-collector exposed part 21C3 and the positive-electrode-current-collector exposed part 21C4 are the same as each other. Stated another way, in a state where the electrode body 20 is released, a distance from an end on the winding center side of the positive electrode 21 to an end on the winding center side of the insulating member 25A1 in the longitudinal direction may be the same as a distance from the end on the winding center side of the positive electrode 21 to an end on the winding center side of the insulating member 25A2 in the longitudinal direction.

In the embodiments described above, a case where the electrode body 20 includes the insulating member 25A1 and the insulating member 25A2 in the positive-electrode-current-collector exposed part 21C1 and the positive-electrode-current-collector exposed part 21C2, respectively has been described, but the present disclosure is not limited to this. For example, as illustrated in FIG. 6C, the electrode body 20 may include a single insulating member 25A3 that covers both the positive-electrode-current-collector exposed part 21C1 and the positive-electrode-current-collector exposed part 21C2. In this case, the insulating member 25A3 is folded back at an end on the winding center side of the positive electrode 21, and covers the entirety of the positive-electrode-current-collector exposed part 21C1 and the positive-electrode-current-collector exposed part 21C2. Furthermore, the insulating member 25A3 also covers a difference in level at a boundary between the positive-electrode-current-collector exposed part 21C1 and the positive electrode active material layer 21B1 and a difference in level between the positive-electrode-current-collector exposed part 21C1 and the positive electrode active material layer 21B2.

In the embodiments described above, a case where the positive electrode 21 includes the positive-electrode-current-collector exposed part 21C3 in which the center-side end of the positive-electrode-current-collector exposed part 21C 1 is not covered with the insulating member 25A1 and is exposed, and the positive-electrode-current-collector exposed part 21C4 in which the center-side end of the positive-electrode-current-collector exposed part 21C2 is not covered with the insulating member 25A2 and is exposed has been described, but the present disclosure is not limited to this. For example, as illustrated in FIG. 6D, the entirety of the positive-electrode-current-collector exposed part 21C1 may be covered with the insulating member 25A1, and the entirety of the positive-electrode-current-collector exposed part 21C2 may be covered with the insulating member 25A2.

Furthermore, the entirety of the positive-electrode-current-collector exposed part 21C1 may be covered with the insulating member 25A1; whereas the center-side end of the positive-electrode-current-collector exposed part 21C2 may be exposed without being covered with the insulating member 25A2, and a positive-electrode-current-collector exposed part 21C4 may be formed. Furthermore, the entirety of the positive-electrode-current-collector exposed part 21C2 may be covered with the insulating member 25A2; whereas the center-side end of the positive-electrode-current-collector exposed part 21C1 may be exposed without being covered with the insulating member 25A1, and a positive-electrode-current-collector exposed part 21C3 may be formed.

In the embodiments described above, an example in which the present disclosure is applied to the positive electrode 21 has been described, but the present disclosure may be applied to the negative electrode 22. In this case, the positive electrode 21, the negative electrode 22, and the separators 23A and 23B are wound in such a way that the negative electrode 22 is an innermost peripheral electrode. In the configuration described above, the negative electrode 22 corresponds to a specific example of the “first electrode” of the present disclosure, and the positive electrode 21 corresponds to a specific example of the “second electrode” of the present disclosure.

### EXAMPLES

The present disclosure is described in detail below by using examples, but the present disclosure is not only limited to these examples. Note that in the examples described below, portions that correspond to portions in the embodiments described above are described by using the same reference symbols.

### Example 1

A positive electrode 21 was made as the following. First, 91 parts by weight of lithium cobalt composite oxide (LiCoO₂) serving as a positive electrode active material, 6 parts by weight of graphite serving as a conductive agent, and 3 parts by weight of polyvinylidene fluoride serving as a binding agent were mixed to form a positive electrode mixture, and the positive electrode mixture was dispersed in N-methyl-2-pyrrolidone. Therefore, a pasty positive electrode mixture slurry was formed.

Next, the positive electrode mixture slurry was applied to both faces of a positive electrode current collector 21A including aluminum foil having a belt shape, and was dried. Then, compression molding was performed by using a roll press machine, and positive electrode active material layers 21B1 and 21B2 were formed. Therefore, a positive electrode 21 was obtained. At this time, a position of application of the positive electrode mixture slurry was adjusted in such a way that positive-electrode-current-collector exposed parts 21C1, 21C2, 21D1, and 21D2 are formed on both faces at both ends of the positive electrode 21. A positive electrode current collector 21A having a width We and a thickness Tc that are indicated in Table 1 was used.

Next, a positive electrode tab 31 including aluminum was welded and attached to the positive-electrode-current-collector exposed part 21D2 that is located on an outside face of an outer-peripheral-side end after winding. Next, insulating members (insulating tapes) 25A1, 25A2, 25B1, and 25B2 were respectively stuck onto the four positive-electrode-current-collector exposed parts 21C1, 21C2, 21D1, and 21D2 (see FIG. 2). At this time, the sizes and the stuck positions of the insulating members 25A1 and 25A2 to be stuck onto the positive-electrode-current-collector exposed parts 21C1 and 21C2 that are located at a center-side end after winding were adjusted in such a way that the configuration described below is formed at the center-side end of the positive electrode 21. Stated another way, an end on a winding center side of the insulating member 25A1 was located in a section between an end on the winding center side of the positive electrode 21 and an end on the winding center side of the positive electrode active material layer 21B2, and an end on the winding center side of the insulating member 25A2 was located in a section between the end on the winding center side of the positive electrode 21 and an end on the winding center side of the positive electrode active material layer 21B1.

Furthermore, a length in the winding direction of the positive-electrode-current-collector exposed part 21C3 was caused to be greater than a length in the winding direction of the positive-electrode-current-collector exposed part 21C4. Moreover, an amount of misalignment X of the ends on the winding center side of the insulating members 25A 1 and 25A2 (see FIG. 3A and FIG. 3B) and a length Y of a both-sided current-collector exposed part (see FIG. 3A and FIG. 3B) were set to the values indicated in Table 1.

A negative electrode 22 was made as the following. First, 97 parts by weight of artificial graphite powder serving as a negative electrode active material and 3 parts by weight of polyvinylidene fluoride serving as a binding agent were mixed to form a negative electrode mixture, and the negative electrode mixture was dispersed in N-methyl-2-pyrrolidone. Therefore, a pasty negative electrode mixture slurry was formed.

Next, the negative electrode mixture slurry was applied to both faces of a negative electrode current collector 22A including copper foil having a belt shape, and was dried. Then, compression molding was performed by using a roll press machine, and negative electrode active material layers 22B1 and 22B2 were formed. Therefore, a negative electrode 22 was obtained. At this time, a position of application of the negative electrode mixture slurry was adjusted in such a way that negative-electrode-current-collector exposed parts 22C1, 22C2, 22D1, and 22D2 are formed on both faces at both ends of the negative electrode 22. Copper foil having a width of 20 mm and a thickness of 6 μm was used. Next, a negative electrode tab 32 including nickel was welded and attached to the negative-electrode-current-collector exposed part 22D1 that is located on an inside face of an outer-peripheral-side end after winding. Next, insulating members 26B1 and 26B2 were respectively stuck onto the negative-electrode-current-collector exposed parts 22D1 and 22D2 that are located at the outer-peripheral-side end after winding (see FIG. 2).

An electrolyte solution was prepared as the following. First, ethylene carbonate (EC) and propylene carbonate (PC) were mixed in such a way that the mass ratio EC:PC=1:1, and a mixed solvent was prepared. Next, lithium hexafluorophosphate (LiPF₆) serving as electrolyte salt was dissolved in this mixed solvent to be 1.0 mol/kg, and an electrolyte solution was prepared.

A battery was made as the following. First, the winding device 40 illustrated in FIG. 4 was used to wind the positive electrode 21, the negative electrode 22, and the two separators 23A and 23B, and an electrode body 20 of a winding type that has a flat shape was obtained. As the separators 23A and 23B, a microporous polyethylene film having a thickness of 25 μm was used. Next, a winding stop tape 24 was stuck onto an outermost periphery of the electrode body 20. Next, the electrode body 20 and the electrolyte solution were housed in a housing 11 of a case 10 serving as a metal can. At this time, the positive electrode tab 31 was connected to a positive electrode terminal 13 that is provided in the housing 11, and the negative electrode tab 32 is connected to an inside face of the case 10. Next, a cavity of the housing 11 was covered with a lid 12, and the housing 11 and a periphery of the lid 12 were joined, and therefore the case 10 was sealed. By doing this, an intended battery was obtained.

### Example 2

As illustrated in FIG. 6A, the sizes of the insulating member 25A1 and the insulating member 25A2 were adjusted in such a way that a length in the winding direction of the positive-electrode-current-collector exposed part 21C4 is greater than a length in the winding direction of the positive-electrode-current-collector exposed part 21C3. Furthermore, an amount of misalignment X of ends on the winding center side of the insulating members 25A1 and 25A2 and a length Y of the both-sided current-collector exposed part were set to the values indicated in Table 1. In the other points, processes that are similar to processes in Example 1 were performed, and a battery was obtained.

### Example 3

As illustrated in FIG. 6B, the sizes of the insulating member 25A1 and the insulating member 25A2 were adjusted in such a way that lengths in the winding direction of the positive-electrode-current-collector exposed part 21C3 and the positive-electrode-current-collector exposed part 21C4 are the same. Furthermore, a length Y of the both-sided current-collector exposed part was set to the value indicated in Table 1. In the other points, processes that are similar to processes in Example 1 were performed, and a battery was obtained.

### Example 4

Instead of the insulating member 25A1 and the insulating member 25A2, as illustrated in FIG. 6C, an insulating member (an insulating tape) 25A3 that is folded back at an end on the winding center side of the positive electrode 21 and covers the entirety of the positive-electrode-current-collector exposed part 21C1 and the positive-electrode-current-collector exposed part 21C2 was used. In the other points, processes that are similar to processes in Example 1 were performed, and a battery was obtained.

### Examples 5 and 9 to 13

A positive electrode current collector 21A having a width W_{c} and a thickness Tc that are indicated in Table 2 was used. Sizes and stuck positions of the insulating members 25A1 and 25A2 to be stuck onto the two positive-electrode-current-collector exposed parts 21C1 and 21C2 that are located at the center-side end after winding were adjusted in such a way that an amount of misalignment X of ends on the winding center side of the insulating members 25A1 and 25A2 (see FIG. 6B) and a length Y of the both-sided current-collector exposed part (see FIG. 6B) have the values indicated in Table 2. In the other points, processes that are similar to processes in Example 3 were performed, and a battery was obtained.

### Examples 6, 7, and 14 to 17

A positive electrode current collector 21A having a width We and a thickness Tc that are indicated in Table 2 was used. Sizes and stuck positions of the insulating members 25A 1 and 25A2 to be stuck onto the two positive-electrode-current-collector exposed parts 21C1 and 21C2 that are located at the center-side end after winding were adjusted in such a way that an amount of misalignment X of ends on the winding center side of the insulating members 25A1 and 25A2 (see FIG. 3A and FIG. 3B) and a length Y of the both-sided current-collector exposed part (see FIG. 3A and FIG. 3B) have the values indicated in Table 2. In the other points, processes that are similar to processes in Example 1 were performed, and a battery was obtained.

### Example 8

A positive electrode current collector 21A having a width We and a thickness Tc that are indicated in Table 2 was used. Sizes and stuck positions of the insulating members 25A1 and 25A2 to be stuck onto the two positive-electrode-current-collector exposed parts 21C1 and 21C2 that are located at the center-side end after winding were adjusted in such a way that an amount of misalignment X of ends on the winding center side of the insulating members 25A 1 and 25A2 (see FIG. 6A) and a length Y of the both-sided current-collector exposed part (see FIG. 6A) have the values indicated in Table 2. In the other points, processes that are similar to processes in Example 2 were performed, and a battery was obtained.

### Comparative Example 1

As illustrated in FIG. 6E, a size of the insulating member 25A1 was adjusted in such a way that an end on the winding center side of the insulating member 25A1 is located in a region where the positive electrode active material layer 21B2 is formed. Furthermore, an amount of misalignment X of ends on the winding center side of the insulating members 25A1 and 25A2 and a length Y of the both-sided current-collector exposed part were set to the values indicated in Table 1. In the other points, processes that are similar to processes in Example 1 were performed, and a battery was obtained.

A rate of occurrence of a failure in winding was evaluated as the following. In a process of making an electrode body 20 of a winding type in the winding device 40, when one end of the positive electrode 21 was inserted toward the winding core 41, and an adhesive-layer exposed part of the insulating member 25A1 or the insulating member 25A2 came into contact with the separator 23A or the separator 23B, the winding device 40 stopped due to non-insertion of an electrode. Alternatively, in the process described above, the positive electrode 21 was obliquely inserted, and this was detected as a winding misalignment failure. The rate of occurrence of a failure in winding was obtained according to the formula described below.

Rate of occurrence of failure in winding[%]=[(number of electrode bodies in which the non-insertion of electrode described above has occurred+number of electrode bodies in which the winding misalignment failure described above has occurred)/(number of electrode bodies manufactured in the processes described above)]×100

Table 1 indicates configurations and evaluation results of batteries in Examples 1 to 4 and Comparative Example 1.

TABLE 1

| | | | Length Y of | Width Wc of | Thickness Tc | |
|---|---|---|---|---|---|---|
| | | | both-sided | positive | of positive | Rate of |
| | Structure | Amount of | current- | electrode | electrode | occurrence |
| | on | misalignment | collector | current | current | of failure |
| | winding | X | exposed part | collector | collector | in winding |
| | center side | [mm] | [mm] | [mm] | [μm] | [%] |
| Example 1 | FIG. 3B | 3.3 | 3.0 | 19.0 | 10.0 | 0.5 |
| Example 2 | FIG. 6A | −3.2 | 3.0 | 19.0 | 10.0 | 0.6 |
| Example 3 | FIG. 6B | 0.0 | 5.2 | 19.0 | 10.0 | 0.5 |
| Example 4 | FIG. 6C | 0.0 | 0.0 | 19.0 | 10.0 | 0.0 |
| Comparative | FIG. 6E | 17.0 | 3.0 | 19.0 | 10.0 | 12.5 |
| Example 1 | | | | | | |

Table 2 indicates configurations and evaluation results of batteries in Examples 5 to 17.

TABLE 2

| | | | Length Y of | Width Wc of | Thickness Tc | Rate of |
|---|---|---|---|---|---|---|
| | | | both-sided | positive | of positive | occurrence |
| | | Amount of | current- | electrode | electrode | of failure |
| | Structure | misalignment | collector | current | current | in |
| | on winding | X | exposed part | collector | collector | winding |
| | center side | [mm] | [mm] | [mm] | [μm] | [%] |
| Example 5 | FIG. 6B | 0.0 | 3.0 | 19.0 | 10.0 | 0.0 |
| Example 6 | FIG. 3B | 0.5 | 3.0 | 19.0 | 10.0 | 0.0 |
| Example 7 | FIG. 3B | 3.0 | 3.0 | 19.0 | 10.0 | 0.0 |
| Example 8 | FIG. 6A | −3.0 | 3.0 | 19.0 | 10.0 | 0.0 |
| Example 9 | FIG. 6B | 0.1 | 0.0 | 19.0 | 10.0 | 0.0 |
| Example | FIG. 6B | 0.1 | 5.0 | 19.0 | 10.0 | 0.0 |
| 10 | | | | | | |
| Example | FIG. 6B | 0.1 | 4.0 | 19.0 | 10.0 | 0.0 |
| 11 | | | | | | |
| Example | FIG. 6B | 0.1 | 3.0 | 14.0 | 10.0 | 0.0 |
| 12 | | | | | | |
| Example | FIG. 6B | 0.1 | 3.0 | 19.0 | 12.0 | 0.0 |
| 13 | | | | | | |
| Example | FIG. 3B | 3.0 | 5.5 | 19.0 | 10.0 | 1.4 |
| 14 | | | | | | |
| Example | FIG. 3B | 3.0 | 8.0 | 19.0 | 10.0 | 3.0 |
| 15 | | | | | | |
| Example | FIG. 3B | 5.0 | 3.0 | 26.0 | 10.0 | 1.0 |
| 16 | | | | | | |
| Example | FIG. 3B | 5.0 | 3.0 | 19.0 | 20.0 | 1.0 |
| 17 | | | | | | |

It should be understood that in Tables 1 and 2, a “positive amount of misalignment X” indicates a state where a length in the winding direction of the positive-electrode-current-collector exposed part 21C3 is greater than a length in the winding direction of the positive-electrode-current-collector exposed part 21C4 (see FIG. 3B). On the other hand, a “negative amount of misalignment X” indicates a state where a length in the winding direction of the positive-electrode-current-collector exposed part 21C4 is greater than a length in the winding direction of the positive-electrode-current-collector exposed part 21C3 (see FIG. 6A).

The below is apparent from Table 1.

A rate of occurrence of a failure in winding can be reduced, by causing an end on the winding center side of the insulating member 25A1 to be located in a section between a center-side end of the positive electrode 21 and an end of the positive electrode active material layer 21B2, and causing an end on the winding center side of the insulating member 25A2 to be located in a section between the center-side end of the positive electrode 21 and an end of the positive electrode active material layer 21B1.

The below is apparent from Table 2.

If an amount of misalignment X of ends (distal ends) on the winding center side of the insulating members 25A1 and 25A2 fall within a range in which−3.0 mm≤X≤3.0 mm, the rate of occurrence of a failure in winding can be reduced.

If a length Y of the both-sided current-collector exposed part falls within a range in which 0 mm K Y s 5.0 mm, the rage of occurrence of a failure in winding can be reduced to 0%.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
an electrode body having a winding structure, the electrode body including:
a first electrode having a first belt shape;
a second electrode having a second belt shape; and
a separator having a third belt shape, the separator being provided between the first electrode and the second electrode; and
an electrolyte, wherein
an electrode that is located at an innermost periphery from among the first electrode and the second electrode includes:
a current collector that includes a first principal face and a second principal face;
a first active material layer that is provided on the first principal face in such a way that a first current-collector exposed part is provided at an end on a winding center side of the electrode;
a second active material layer that is provided on the second principal face in such a way that a second current-collector exposed part is provided at the end on the winding center side of the electrode;
a first insulating member; and
a second insulating member, wherein
the first insulating member covers a boundary between the first active material layer and the first current-collector exposed part, and the first current-collector exposed part,
the second insulating member covers a boundary between the second active material layer and the second current-collector exposed part, and the second current-collector exposed part,
the first insulating member and the second insulating member overlap each other to sandwich the current collector,
widths of the first insulating member and the second insulating member in a shorter side direction of the electrode are greater than a width of the electrode in the shorter side direction of the electrode,
the second insulating member is located on the second principal face between the end on the winding center side of the electrode and an end of the first active material layer, and
the first insulating member is located on the first principal face between the end on the winding center side of the electrode and an end of the second active material layer.

2. The battery according to claim 1, wherein
an amount of misalignment of ends on the winding center side of the first insulating member and the second insulating member is less than or equal to 3.0 mm.

3. The battery according to claim 1, wherein
the electrode includes:
a third current-collector exposed part in which an end on the winding center side of the first current-collector exposed part is not covered by the first insulating member, and is exposed; and
a forth current-collector exposed part in which an end on the winding center side of the second current-collector exposed part is not covered by the second insulating member, and is exposed, and
a length of a portion where the third current-collector exposed part and the fourth current-collector exposed part overlap each other in a thickness direction of the electrode is less than or equal to 5 mm.

4. The battery according to claim 2, wherein
the electrode includes:
a third current-collector exposed part in which an end on the winding center side of the first current-collector exposed part is not covered by the first insulating member, and is exposed; and
a forth current-collector exposed part in which an end on the winding center side of the second current-collector exposed part is not covered by the second insulating member, and is exposed, and
a length of a portion where the third current-collector exposed part and the fourth current-collector exposed part overlap each other in a thickness direction of the electrode is less than or equal to 5 mm.

5. The battery according to claim 1, wherein
the electrode body has a flat shape,
the electrode includes a single-sided electrode part in which the first active material layer is not provided on the first principal face, the first principal face serves as the first current-collector exposed part, and the second active material layer is provided on the second principal face,
the single-sided electrode part includes a curved part, and
a region that corresponds to the curved part of the single-sided electrode part in the first current-collector exposed part is covered by the first insulating member.

6. The battery according to claim 2, wherein
the electrode body has a flat shape,
the electrode includes a single-sided electrode part in which the first active material layer is not provided on the first principal face, the first principal face serves as the first current-collector exposed part, and the second active material layer is provided on the second principal face,
the single-sided electrode part includes a curved part, and
a region that corresponds to the curved part of the single-sided electrode part in the first current-collector exposed part is covered by the first insulating member.

7. The battery according to claim 3, wherein
the electrode body has a flat shape,
the electrode includes a single-sided electrode part in which the first active material layer is not provided on the first principal face, the first principal face serves as the first current-collector exposed part, and the second active material layer is provided on the second principal face,
the single-sided electrode part includes a curved part, and
a region that corresponds to the curved part of the single-sided electrode part in the first current-collector exposed part is covered by the first insulating member.

8. The battery according to claim 1, wherein
a width of the current collector ranges from 5 mm to 25 mm inclusive.

9. The battery according to claim 2, wherein
a width of the current collector ranges from 5 mm to 25 mm inclusive.

10. The battery according to claim 3, wherein
a width of the current collector ranges from 5 mm to 25 mm inclusive.

11. The battery according to claim 5, wherein
a width of the current collector ranges from 5 mm to 25 mm inclusive.

12. The battery according to claim 1, wherein
a thickness of the current collector ranges from 5 μm to 15 μm inclusive.

13. The battery according to claim 2, wherein
a thickness of the current collector ranges from 5 μm to 15 μm inclusive.

14. The battery according to claim 3, wherein
a thickness of the current collector ranges from 5 μm to 15 μm inclusive.

15. The battery according to claim 5, wherein
a thickness of the current collector ranges from 5 μm to 15 μm inclusive.

16. The battery according to claim 8, wherein
a thickness of the current collector ranges from 5 μm to 15 μm inclusive.

17. The battery according to claim 1, wherein
the first electrode is a positive electrode,
the second electrode is a negative electrode,
the positive electrode includes a positive electrode tab that is provided on an outermost peripheral side of the positive electrode, and
the negative electrode includes a negative electrode tab that is provided on the outermost peripheral side of the negative electrode.

18. The battery according to claim 1, wherein the electrode is a positive electrode.

19. The battery according to claim 1, further comprising:
a metal can that accommodates the electrode body and the electrolyte, wherein
a negative electrode is wound at an outermost periphery of the electrode body,
the negative electrode includes a negative electrode current collector and a negative electrode active material layer, and
the negative electrode current collector that is exposed is in contact with an inside face of the metal can.
